(19) United States
(12) Patent Application Publication
(10) Pub. No.: US 2008/0111824 A1
(43) Pub. Date: May 15, 2008

(54) Quality Assurance Method for Use in System with Limited Memory

(75) Inventors: Maximilian Munte, Munich (DE); Sergej Wetzstein, Munich (DE)

Correspondence Address: Oppedahl Patent Law Firm LLC, P.O. BOX 4850, FRISCO, CO, 80443-4850, US

(73) Assignee: Comombo Gmbh i. G., Muenchen (DE)

(21) Appl. No.: 11/621,143

(22) Filed: Jan. 9, 2007

Related U.S. Application Data
(60) Provisional application No. 60/865,393, filed on Nov. 10, 2006.

(51) Int. Cl. G06T 9/00

(52) U.S. Cl. 345/555

(57) ABSTRACT

In a terminal device such as a portable consumer electronic device, the device having only limited computational memory, a large compressed image file such as a JPEG file, having some color depth such as 24 bits per pixel, is collapsed to a bit-mapped image file with very little color depth, such as 1 bit per pixel. This collapse may be carried out in situ in the computational memory of the device. The bit-mapped image will be of some large row-and-column pixel count. A display mechanism within the device may then display a window (within the bit-mapped image) of a row-and-column pixel count that is smaller than that of the bit-mapped image. For purposes of this display the bit-mapped information to be displayed may be of a color depth of two and maybe mapped back to a 24-bit color space to accommodate the display hardware and/or firmware. In this way, a human user can perform a quality-assurance review upon a photograph of high pixel count even though the system may have only very limited computational memory and only limited display size, all with application response time consistent with the expectations of the human user.

The invention relates generally to quality assurance for images in portable and handheld consumer electronic devices, and relates more particularly to ways to achieve quality assurance in limited-memory environments.

### BACKGROUND

It is not easy to fit complex and demanding applications into the limited execution spaces that are available in some portable consumer electronic devices. Many commentators have noted a trend of “convergence” in which makers of such devices tend to try to combine hitherto separate functions into a single device. A cell phone may have a camera integrated into it. A personal digital assistant may have a cell phone integrated into it. Any of these devices may have an MP3 (music file) player included among its functions. Design constraints for such devices often include:
weight
a limited energy (battery) budget
size and form factor
allocation of surface real estate for keyboards and displays
cost
performance goals
quickness or sluggishness of system response to user inputs

This “convergence” together with such constraints leads to situations where system designers make decisions that may be less than optimal for the addition of applications in a device.

An exemplary portable consumer electronic device is a cell phone (wireless telephone). Such a phone may have a camera and the user may be able to take photographs with a resolution of, say, 3 megapixels. Each pixel may capture 24 bits of color information (eight bits for each of three colors) leading to nine megabytes of captured data. In an exemplary device the captured data are immediately compressed, for example with JPEG compression, so that the stored information (after compression) amounts to, say, 750 kilobytes. Stated differently the compression may work out to an exemplary 12:1 ratio.

Such JPEG compression is necessarily “lossy” meaning that if and when the file is decompressed back to its original size (e.g. for display or printing purposes) it will have lost some information as compared with the information that was originally captured.

As mentioned above, the designer of a device will make decisions such as how much fast RAM is provided, how much slow FLASH memory is provided, and the size of display provided. There will also be constraints such as the bandwidth available for transmitting data from the device to other devices, for example via GPRS, EDGE, UMTS, HSDPA, EVDO, Bluetooth, etc.

In an exemplary cell phone the memory available for graphics and video might be 3000 kilobytes. The usual display hardware is such that to drive the display based upon information stored in the graphics/video memory, the stored information needs to be bit-mapped. In such a system, each pixel of an image is represented by 24-bit (3-byte) per pixel. This might be 16 bits per pixel of RGB information and 8 bits per pixel of alpha-channel. Alternatively it might be 8 bits of red information, 8 bits of blue information, and 8 bits of green information. It will be appreciated that with such a memory the maximum size of the image to be displayed is 1 million pixels. If it were desired to display an image bigger than 1 million pixels, the device would be running out of memory.

A related problem arises when one considers that the display on the device will very likely have far fewer pixels than the number of pixels that the camera is able to capture. As an example a 3-megapixel image will typically be 2048 by 1536 pixels. A typical liquid-crystal display screen may be 320 by 240 pixels. This leads to problems if, for example, one wishes to use the display for the purpose of carrying out a quality review to see whether a just-taken photograph is clear and of the desired quality. With most hardware arrangements, the display is driven based upon information stored in bit-mapped fashion in memory. But the photographic image file, as mentioned above, will be compressed. This leads to a problem that it is mathematically impossible to view an arbitrarily selected portion of a JPEG file other than by performing (decompression) calculations from the start of the JPEG file all the way to the selected portion.

Scrolling a 320-by-240 window (which requires bit-mapped information) back and forth and up and down within a JPEG image of 2048-by-1536 (which is not bit-mapped) in an environment of limited RAM can lead to a computationally intensive process that would not be workable as it would be far too slow.

Yet another related problem arises because the bandwidth of the wide-area-network communications channel (for example the above-mentioned UMTS) is not infinite. If a large file is to be transmitted (e.g. a color JPEG) it may take some time to transmit the entirety of the file. With some carriers there is a cost-per-bit for the transmission of data. But if only a suitable quality-assurance review could be carried out, it might turn out that a “flattened” file could be sent instead of the color file. For example the color image might be collapsed to a “color depth” of 2, where each pixel is either black or white. Such a file would not take nearly as long to transmit and might not cost as much money to transmit.

It would thus be very desirable if an approach could be found that would permit viewing, for quality-assurance purposes, of all or portions of a captured image, even though the system has only very limited memory for driving the display. It would be desirable if such an approach would provide a fast response to user inputs such as scrolling inputs. It would be desirable if such an approach could lead to images that do not take too long to transmit over a WAN channel. Such an approach might well be very helpful, too, in making it possible for a user of a device to visit web sites having screen areas that are far too large for normal display on the display of the device.

### SUMMARY OF THE INVENTION

In a terminal device such as a portable consumer electronic device, the device having only limited computational memory, a large compressed image file such as a JPEG file, having some color depth such as 24 bits per pixel, is collapsed to a bit-mapped image file with very little color depth, such as 1 bit per pixel. This collapse may be carried out in situ in the computational memory of the device. The bit-mapped image will be of some large row-and-column pixel count. A display mechanism within the device may then display a window (within the bit-mapped image) of a row-and-column pixel count that is smaller than that of the bit-mapped image. For purposes of this display the bit-mapped information to be displayed may be of a color depth of two and maybe mapped back to a 24-bit color space to accommodate the display hardware and/or firmware. In this way, a human user can perform a quality-assurance review upon a photograph of high pixel count even though the system may have only very limited computational memory and only limited display size, all with application response time consistent with the expectations of the human user.

### DESCRIPTION OF THE DRAWING

The invention will be described with respect to a drawing in several figures, of which:

FIG. 1 shows a functional block diagram of an exemplary device; and

FIG. 2 shows diagrammatically the image formats and file sizes in a typical sequence of quality-assurance steps.

### DETAILED DESCRIPTION

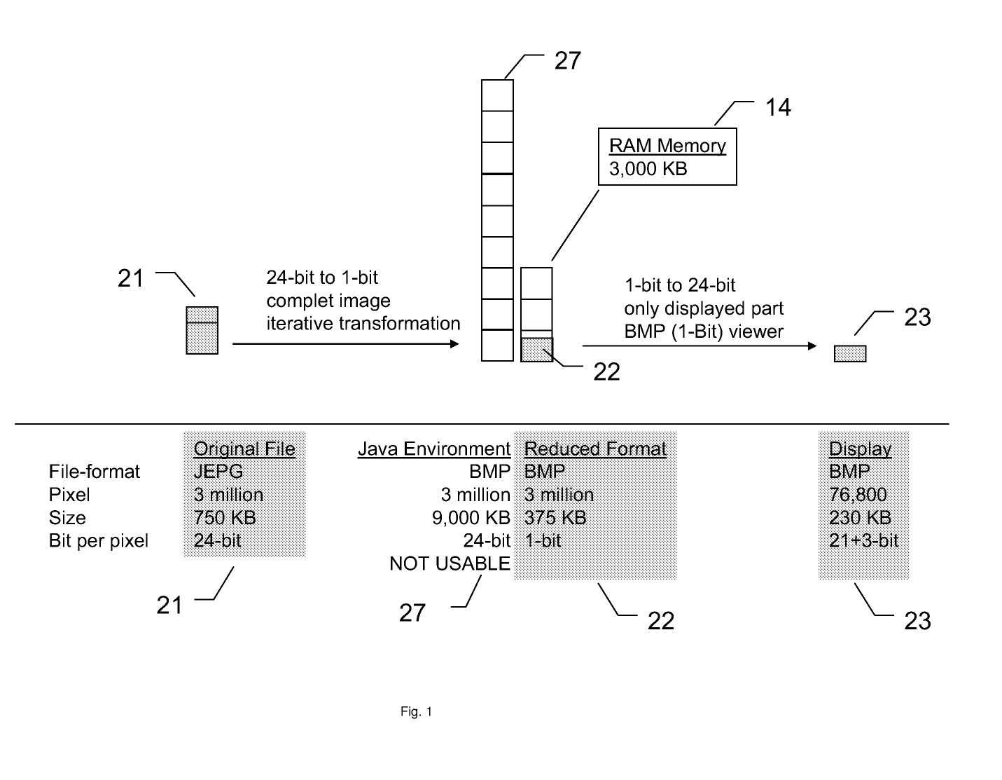

FIG. 1 shows a functional block diagram of an exemplary device 10. There is a large slow memory 12 which does not consume much of the energy budget of the device. There is a computational memory 14 a portion of which, under operating system control, is able to drive a display 15. A camera 11 is used to take photographs. A wireless wide-area-network (WAN) port 18 permits data communications with equipment external to the device, said equipment omitted for clarity in FIG. 1.

A processor 17 runs a suitable operating system such as Simbian. As will be described below, according to an exemplary embodiment of the invention, a Java application according to the invention may run on the operating system, to permit performing quality assurance upon images captured by the camera 11. A captured image that passes the quality assurance will then be transmitted to equipment external to the device by means of the WAN port 18.

Other common operating systems include Simbian S40/S60/S80, Windows Mobile, and proprietary OSs from Sony-Ericsson, Motorola and Samsung. The Java used for the exemplary applications may be J2ME (Java 2 Micro Environment).

In an exemplary cell phone, the memory 14 is an assembly of different memories allocated by the operating system. The Java programmer who is writing Java code to run in this cell phone has little or no ability to influence which particular memory is used; this is controlled by the operating system.

Other system components, omitted for clarity in FIG. 1, allow the device 10 optionally to serve as a cell phone or as a personal digital assistant or as an MP3 (music) player.

Importantly, the design decisions of the designer of the device 10 may well have led to a situation where the camera 11 takes pictures which are simply impossible to display on the display 15 due to the limited size of the computational memory 14.

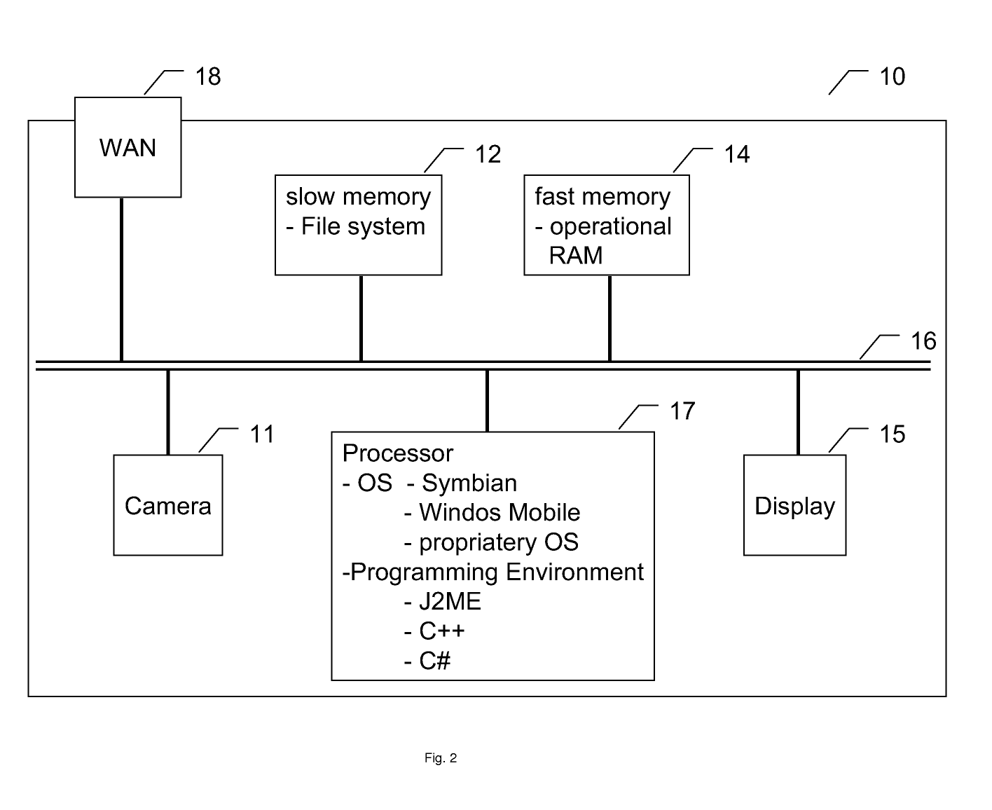

FIG. 2 shows diagrammatically the image formats and file sizes in a typical sequence of quality-assurance steps. The starting point is an image 21 in JPEG format, using 750 kilobytes to represent an image that is 3 megapixels in size, each pixel renderable on a display with 24-bit color. The JPEG will have been compressed at a ratio of 12:1 in an exemplary embodiment.

One may then hypothetically discuss expanding the image 21 back to its full 3 million pixels (in bit-mapped fashion), each pixel portrayed with 24 bits of information. This requires 72 million bits or 9 million bytes, and this hypothetical data file is portrayed as image 27. But for sake of discussion the memory 14 was assumed to be smaller, for example 3 million bytes in size. It is simply not possible to fit the bit-mapped version 27 of image 21 into the available computational memory 14. It would be like trying to fit 9 kilograms of nails into a bag that is sized to carry 3 kilograms of nails.

Importantly, what is done next is to perform a decompression of the JPEG image file 21 into a bit-mapped file 22. The bit-mapped file 22 has a color depth of only two, meaning that there is one bit per pixel. There are 3 million pixels and thus the file 22 is 3 million bits in size. That works out to 375 kilobytes.

It is then within grasp to use the standard video display mechanism of the device to display selected portions of the file 22. The display mechanism of the device may be freely scrolled up and down and left and right to display (for example) a 320-by-240-pixel window within an image of 2048-by-1536 pixels. This scrolling can be fast and can be carried out with little or no computational burden.

Depending on the particular display hardware, it may be necessary to expand the color depth of two (one bit per pixel) back to a color depth of 24 bits per pixel. This mapping, however, is quite easy to do and does not require burdensome calculation. A black pixel is mapped to the 24-bit value for the color “black,” and a white pixel is mapped to the 24-bit value for the color “white.”

Returning now to the collapsing process, it should be appreciated that the steps of the method do not require building the image 27. This is fortunate since the device probably does not have anywhere near enough computational memory to build the image 27. Instead, the application iterates through the pixels of the JPG, discarding its content as it goes along, and stores in its place the 1-bit-per-pixel information. This is preferably done row-wise. A row of the JPEG file is decompressed, the color depth for that row is collapsed, and the derived row pixel information is stored in memory in the location where the row of JPEG information had previously been stored. This in situ approach conserves memory.

Stated differently, the application performs this collapse by decoding a first line of tiles from the JPEG file, which then becomes a 24-Bit-Map for the tiles (pixels) in that row. After the application binarizes that first line of tiles, a 1-Bit-Map is derived. Then the application throws the first line of tiles out of the memory, but keeps the 1-Bit-Map in memory.

Then the application decodes the second line of tiles from the JPEG. The application adds the second line of tiles to the 1-Bit-Map. This repeats until the whole JEPG is decoded and saved in a 1-Bit-Map file (file 22 in FIG. 2).

Then a display functionality (a viewer application) is invoked to display a portion of the 1-bit-map file. This may be a display window of 76800 pixels, as mentioned above. The viewer application provides horizontal and vertical scroll bars or uses some alternative method like direction arrows.

Again, the 1-bit-map file may be used as a starting point to develop a 24-bit-per-pixel bit-map file 23 that is sized to match the display 15. This file may be 230 kilobytes in size.

Importantly, the approach described here is able to work even in very limited computational memory. The approach requires:
the 375 KB 1-Bit-Map, 3 million pixel, file 22, and
the 230 KB 24-Bit-Map, 76800 pixel, an array of 320×240 pixel (display resolution) file 23.

Reviewing, the approach uses a viewer application, which can dynamically take a defined array of pixels (320×240) from the 1-Bit-Map file 22 and transforms it to the viewable 24-Bit-Map file 23. In this way it is easy to scroll through the whole picture without loading and saving data to the slow memory 12.

In an exemplary embodiment, the above-mentioned Java class GRAPHICS library provides several methods (functions), for example the function drawRGB( ) which renders a series of device-independent RGB values (24 bit) in a specified region. Before an array of an image can be displayed, it is necessary to retrieve exactly this array of data 23 out of the whole image data.

A first procedure will now be described in some detail, which starts with a JPEG file, for example (750 KB in size).
It is binarized to a 1-bit-map file (350 KB in size).
A lossless compression is then applied and what is received is a TIFF-G3 file that is 10 to 20 KB in size. (This is the same file format as used in fax machines.)

Such a file is the best way to send (e.g. to fax) a document to a document archive without having big data volumes or long data transfer times.

But as was discussed above, there is a need for quality assurance. What if the image were too dark or too light? One would not want to send the image to a remote archive and then delete the original image from the user device (e.g. the cell phone) only to find out later that the received image is unreadable.

It will be appreciated that a difference between a mobile camera and a fax machine is that the fax has almost laboratory conditions when it scans/binarizes the document. With a fax machine, one knows with fairly good confidence how the document quality will be at the receiver's end. In contrast, with the image from the mobile phone, with all its lights, shadows and reflections on it, one can never guess how well it will be at the receiver's end.

So the approach of the invention is to have a visual quality check of the black-and-white image before it is sent to the remote archives But as described above, such a check runs into an out-of-memory issue. The approach of the invention solves this memory issue.

Another sequence of steps will now be described in detail.

The one-bit image is used to provide a display, in a limited-memory runtime environment, that permits checking the original (24-bit) image quality.

Thereafter, if the image passes the quality review, then the original image is sent to the receiver. After all, if the “collapsed image” (the one-bit image) passes quality review, then by definition the original image will pass.

Alternatively, what is sent to the receiver is a reduced size image such as a one-bit-per-pixel image or a two-bit-per-pixel image. (Any suitable reduction could be used.)

It is thus instructive to review what has been accomplished.

The approach relates to a method to visually control the quality of an image, which processing requires more memory resources than are available in the runtime environment of the processing terminal. The runtime environment is restricted because of the available graphic memory of given hardware and because of the programming language used to implement such a method.

The objective of the approach is to display the image on the display of the terminal to the person operating the terminal, so the quality of the image can visually be checked by the operator. Importantly, the image is displayed in a low quality as compared with the quality of the original image. If the lower-quality image is found to be sufficient, them the quality of the original must be sufficient as well.

In a typical user system, the image is intended to be a representation of a document with manual or machine written text, such as a receipt or sales slip as described in U.S. Pat. No. 6,991,158 entitled “Mobile paper record processing system.” The operator will of course want to control the image quality to see if the text is readable. The original image is stored in common memory of the terminal in JEPG format. Also given that the bitmap-size of the image is bigger than the available graphic/video memory, one can display the picture by performing the following method comprising:
Decoding the JEPG image while (in parallel) reducing the memory usage of the image by eliminating selected information on a pixel basis, (e.g. binarization reduces the 24 bit per pixel to 1-bit per pixel).
The size-reduced image can now be loaded into the memory as a 1-bit bitmap.
To display the image one can populate the graphic/video memory with the required pixel data by transforming the 1-bit representation of a pixel to a 24-bit bitmap required by the display processes.

Those skilled in the art will have no difficulty devising myriad obvious variants and improvements, none of which depart from the invention itself, and all of which are intended to be embraced within the claims which follow.

1. A method performed with respect to a first image having a size, the first image having been compressed, the first image having a first color depth, the method carried out in an execution environment with a computational memory of a size, the first size smaller than the size of a decompressed bit-mapped version of the first image, the method comprising the steps of:
decompressing the first image, collapsing the color depth of each pixel of the first image to a second color depth, the second color depth less than the first color depth, thereby yielding a second bit-mapped image having a size smaller than the size of the first image, the second bit-mapped image smaller in size than the computational memory and thereby able to fit into the computational memory;
displaying a first part of the second image on a bit-mapped display; and thereafter,
displaying a second part of the second image on the bit-mapped display;
the displaying of the first part of the image and the displaying of the second part of the image not requiring any intervening decompression activity.

2. The method of claim 1 wherein the first image is a 24-bit-per-pixel JPEG image and the second image is a one-bit-per-pixel bit-mapped image.

3. The method of claim 1 wherein the decoded portions of the first image are discarded row-wise as the derived smaller-color-depth portions of the second image are stored row-wise.

4. The method of claim 1 wherein displaying a first part of the second image on a bit-mapped display comprises expanding the color depth of the second image to a larger color depth.

5. The method of claim 4 wherein the expanded color depth is 24 bits per pixel.

6. The method of claim 1 further comprising reviewing at least portions of the second image as displayed, and after the reviewing, transmitting the first image to a remote location by means of a wireless link.

7. The method of claim 1 further comprising reviewing at least portions of the second image as displayed, and after the reviewing, transmitting the second image to a remote location by means of a wireless link.

8. The method of claim 1 further comprising reviewing at least portions of the second image as displayed, and after the reviewing, transmitting to a remote location by means of a wireless link the second image after it has been compressed with a lossless compression.

9. The method of claim 8 wherein the lossless compression is a group III TIFF compression.

10. A method performed with respect to a first image having a size, the first image having been compressed, the first image having a first color depth, the method carried out in an execution environment with a computational memory of a size, the first size smaller than the size of a decompressed bit-mapped version of the first image, the method comprising the steps of:
decompressing the first image, collapsing the color depth of each pixel of the first image to a second color depth, the second color depth less than the first color depth, thereby yielding a second bit-mapped image having a size smaller than the size of the first image, the second bit-mapped image smaller in size than the computational memory and thereby able to fit into the computational memory; and
transmitting the second image to a remote location by means of a wireless link.

11. The method of claim 10 wherein the first image is a 24-bit-per-pixel JPEG image and the second image is a one-bit-per-pixel bit-mapped image.

12. The method of claim 10 wherein the decoded portions of the first image are discarded row-wise as the derived smaller-color-depth portions of the second image are stored row-wise.

13. A method performed with respect to a first image having a size, the first image having been compressed, the first image having a first color depth, the method carried out in an execution environment with a computational memory of a size, the first size smaller than the size of a decompressed bit-mapped version of the first image, the method comprising the steps of:
decompressing the first image, collapsing the color depth of each pixel of the first image to a second color depth, the second color depth less than the first color depth, thereby yielding a second bit-mapped image having a size smaller than the size of the first image, the second bit-mapped image smaller in size than the computational memory and thereby able to fit into the computational memory;
compressing the second image with a lossless compression;
transmitting the compressed second image to a remote location by means of a wireless link.

14. The method of claim 13 wherein the first image is a 24-bit-per-pixel JPEG image and the second image is a one-bit-per-pixel bit-mapped image.

15. The method of claim 13 wherein the decoded portions of the first image are discarded row-wise as the derived smaller-color-depth portions of the second image are stored row-wise.

16. The method of claim 13 wherein the lossless compression is a group III TIFF compression.
